(19) United States
(12) Patent Application Publication
(10) Pub. No.: US 2013/0241501 A1
(43) Pub. Date: Sep. 19, 2013

(54) Charging System

(71) Applicant: NOVATEK MICROELECTRONICS CORP., Hsin-Chu (TW)

(72) Inventor: Cheng-Wen Chang, Hsinchu City (TW)

(73) Assignee: NOVATEK MICROELECTRONICS CORP., Hsin-Chu (TW)

(21) Appl. No.: 13/676,134

(22) Filed: Nov. 14, 2012

(30) Foreign Application Priority Data
Mar. 13, 2012 (TW) 101108428

(51) Int. Cl. H02J 7/00

(52) U.S. Cl. CPC H02J 7/0055
USPC 320/166

(57) ABSTRACT

The present invention discloses a charging system for charging a capacitor. The charge system includes a unit gain buffer, driven by a driving voltage, having a positive input terminal for receiving a target voltage and a negative input terminal coupled to an output terminal, at least one independent voltage source, for providing at least one voltage, a first switch coupled between the unit gain buffer and the capacitor, at least one second switch coupled between the at least one independent voltage source and the capacitor, and a switch control waveform generator, coupled to the first switch and the at least one second switch, for sequentially turning on at least one of the first switch and the at least one second switch for at least one of the unit gain buffer and the at least one independent voltage source to sequentially charge the capacitor.

### BACKGROUND OF THE INVENTION

1. Field of the Invention

The present invention relates to a charging system, and more particularly, to a charging system capable of controlling at least one of a unit gain buffer and at least one independent voltage source to sequentially charge a capacitor according to a range which a target voltage is located, to flexibly reduce power consumption or improve charging speed.

2. Description of the Prior Art

In general, when performing LCD driving, a unit gain buffer is utilized to charge a capacitor of each pixel to a target voltage according to a gray scale of each pixel in each image, to display each image.

For example, please refer to FIG. 1, which is a schematic diagram of a conventional unit gain buffer 10 charging a capacitor 12. As shown in FIG. 1, the unit gain buffer 10 is driven by a driving voltage V_{P}, and includes a positive input terminal for receiving a target voltage V_{T}, and a negative input terminal coupled to an output terminal of the unit gain buffer to form a negative feedback loop, to maintain the output terminal voltage at the target voltage V_{T}. Therefore, the capacitor 12 can be charged to the target voltage V_{T}. In such a condition, total power consumption caused by charging the capacitor 12 can be denoted as: P=I*V=(V_{T}*C*F)*V_{P}, wherein C is capacitance of the capacitor 12, and F is switching frequency of display image, i.e. the capacitor 12 is charged to the target voltage V_{T} in a period of 1/F.

However, the conventional method of charging the capacitor 12 with only the unit gain buffer 10 lacks flexibility in power consumption and charging speed, which may cause power consumption too high or charging speed too low. Thus, there is a need for improvement of the prior art.

### SUMMARY OF THE INVENTION

It is therefore an objective of the present invention to provide a charging system capable of controlling at least one of a unit gain buffer and at least one independent voltage source to sequentially charge a capacitor according to a range which a target voltage is located, to flexibly reduce power consumption or improve charging speed.

The present invention discloses a charging system, for charging a capacitor. The charging system comprises a unit gain buffer, driven by a driving voltage, and including a positive input terminal for receiving a target voltage, and a negative input terminal coupled to an output terminal of the unit gain buffer; at least one independent voltage source, for providing at least one voltage; a first switch, coupled between the output terminal of the unit gain buffer and the capacitor; at least one second switch, coupled between the at least one independent voltage source and the capacitor; and a switch control waveform generator, coupled to the first switch and the at least one second switch, for controlling at least one of the first switch and the at least one second switch to be sequentially turned on in one cycle according to a control signal, to sequentially charge the capacitor with at least one of the unit gain buffer and the at least one independent voltage source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional unit gain buffer charging a capacitor.

FIG. 2A is a schematic diagram of a charging system according to an embodiment of the present invention.

FIG. 2B is a schematic diagram of a voltage to digital code conversion information.

FIG. 2C is a schematic diagram of dividing a driving voltage into three ranges.

FIG. 2D is a schematic diagram of three waveform signals.

FIG. 2E to FIG. 2G are schematic diagrams of three switches to be turned on in one cycle under different conditions.

FIG. 3A is a schematic diagram of another charging system according to an embodiment of the present invention.

FIG. 3B is a schematic diagram of dividing a driving voltage into four ranges.

FIG. 3C is a schematic diagram of four waveform signals.

FIG. 3D to FIG. 3G are schematic diagrams of four switches to be turned on in one cycle under different conditions.

FIG. 4 and FIG. 5 are schematic diagrams of other two charging systems according to an embodiment of the present invention.

FIG. 6A and FIG. 7A are schematic diagrams of further two charging systems according to an embodiment of the present invention.

FIG. 6B and FIG. 7B are schematic diagrams of voltage range determination circuits shown in FIG. 6A and FIG. 7A, respectively.

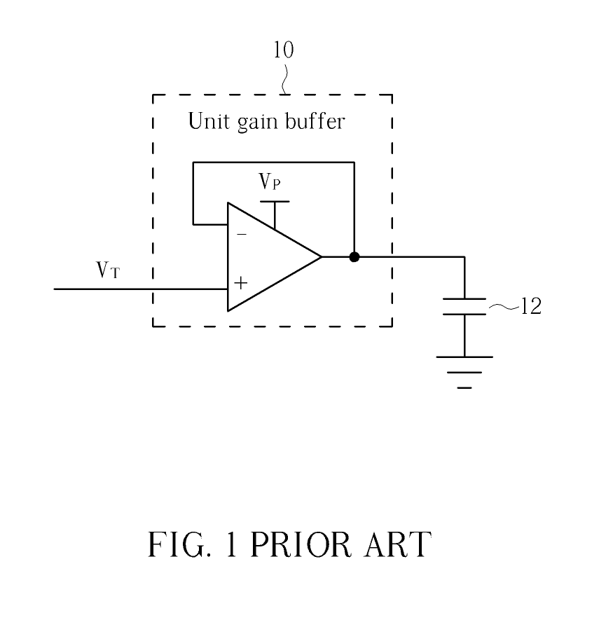

### DETAILED DESCRIPTION

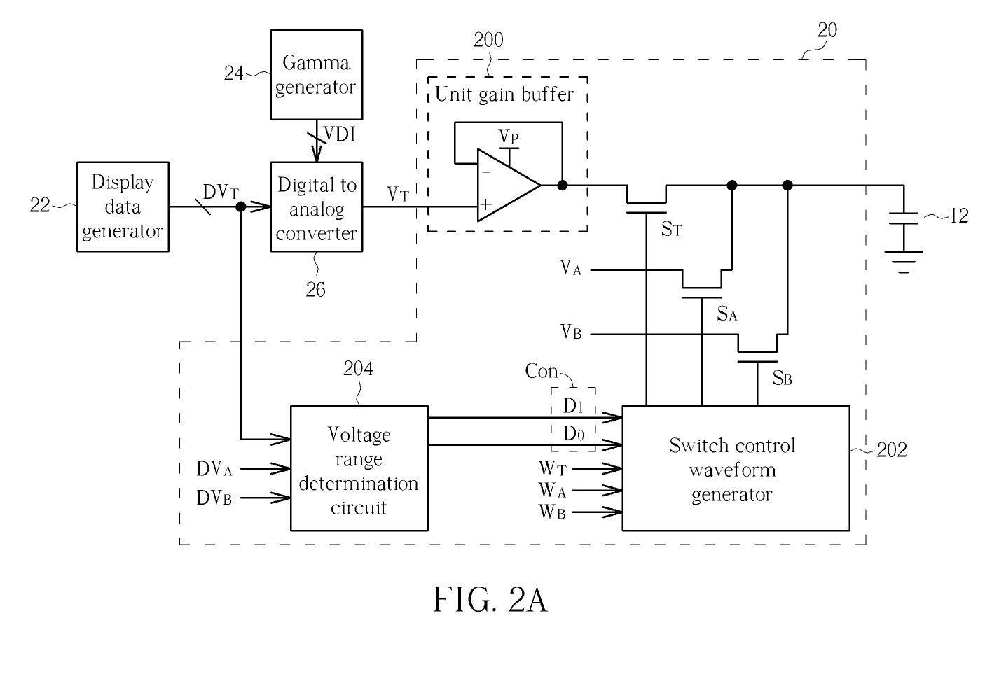

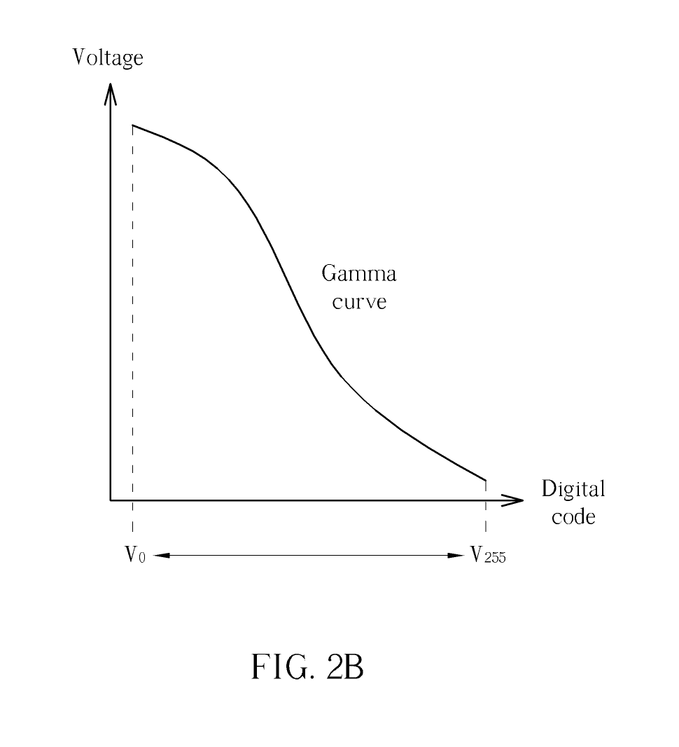

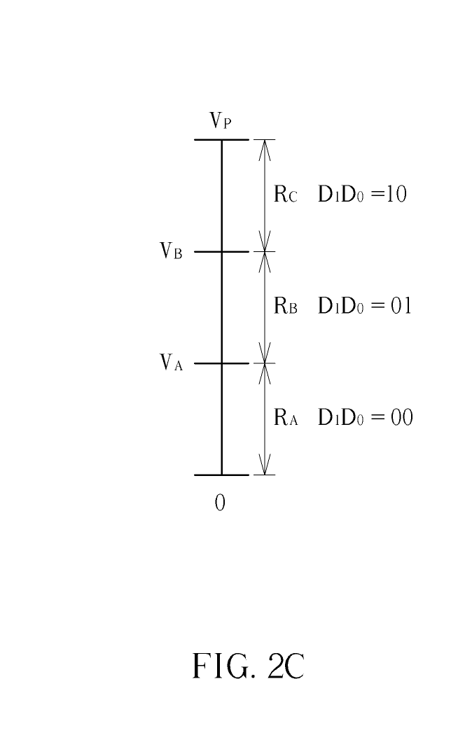

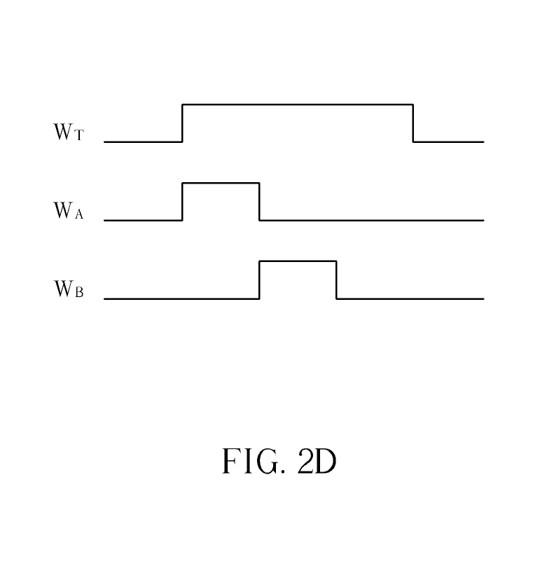

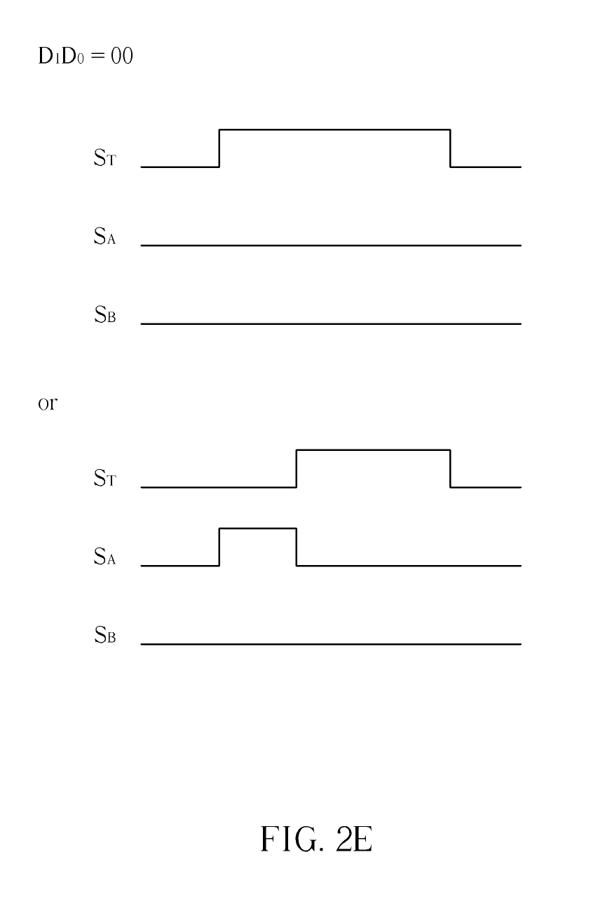

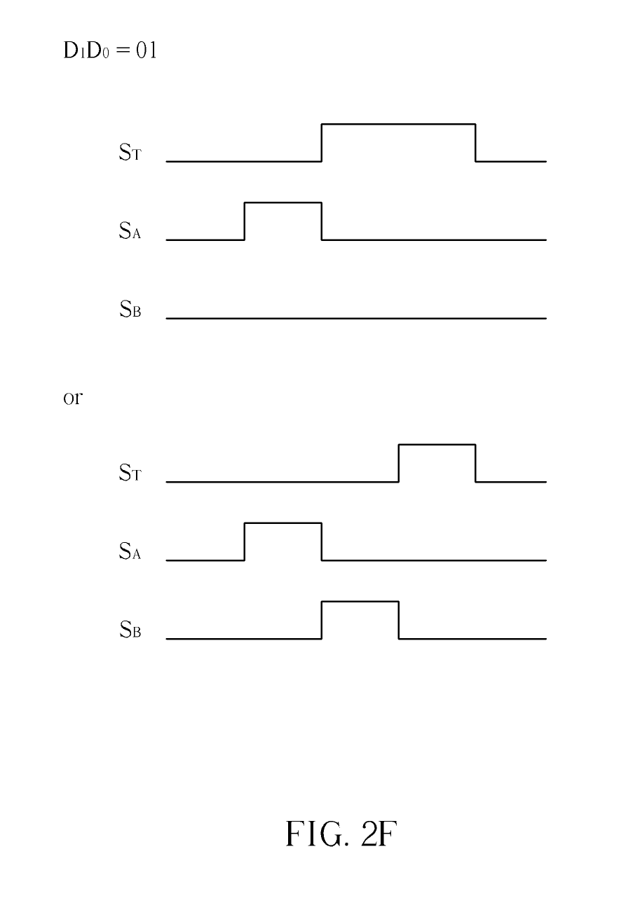

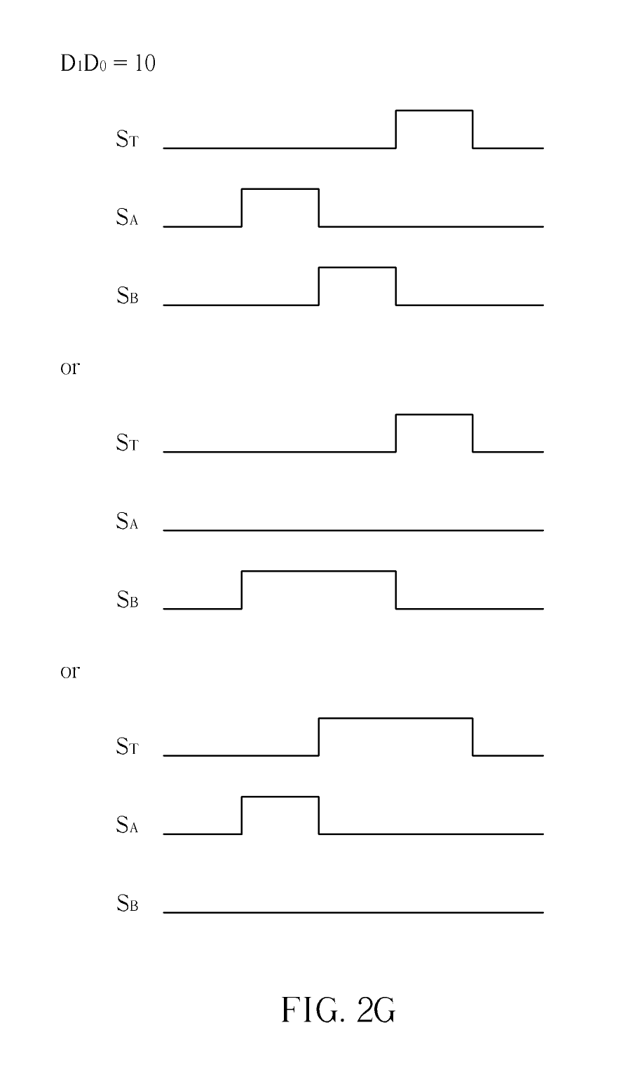

Please refer to FIG. 2A, which is a schematic diagram of a charging system 20 according to an embodiment of the present invention. As shown in FIG. 2A, the charging system 20 is utilized for charging the capacitor 12, and includes a unit gain buffer 200, independent voltage sources VS_{A} and VS_{B}, switches S_{T}, S_{A}, and S_{B}, and a switch control waveform generator 202. The unit gain buffer 200 is similar to the unit gain buffer 10, and is driven by a driving voltage V_{P}. The unit gain buffer 200 includes a positive input terminal for receiving a target voltage V_{T}, and a negative input terminal coupled to an output terminal of the unit gain buffer 200 to form a negative feedback loop, to maintain the output voltage at the target voltage V_{T}, wherein the target voltage V_{T} is usually set to be less than the driving voltage V_{P}, such that the unit gain buffer 200 can maintain the output voltage at the target voltage V_{T}. The independent voltage sources VS_{A} and VS_{B} provide voltages V_{A} and V_{B}, respectively. The switch S_{T} is coupled between the output terminal of the unit gain buffer 200 and the capacitor 12, and the switches S_{A} and S_{B} are coupled between the independent voltage sources VS_{A} and VS_{B}, and the capacitor 12. The switch control waveform generator 202 is couple to control terminals of the switches S_{T}, S_{A}, and S_{B}, and controls at least one of the switches S_{T}, S_{A}, and S_{B} to be sequentially turned on in one cycle according to a control signal Con, which includes control codes D₀ and D₁, to sequentially charge the capacitor 12 with at least one of the unit gain buffer 200 and the independent voltage sources VS_{A} and VS_{B}. As a result, the switch control waveform generator 202 can flexibly switch a charging source of the capacitor 12 according to the control signal Con, to reduce power consumption or improve charging speed.

In detail, the switch control waveform generator 202 can control the independent voltage source VS_{A} to charge the capacitor 12 to the corresponding voltage V_{A} first, i.e. turn on the switch S_{A}, and then control the unit gain buffer 200 to charge the capacitor 12 to the target voltage V_{T}. In such a condition, if the voltage V_{A} is less than the target voltage V_{T} and less than the driving voltage V_{P}, total power consumption caused by charging the capacitor 12 is P=I*V=(V_{A}*C*F)*V_{A}+((V_{T}−V_{A})*C*F)*V_{P}, which is less than total power consumption caused by the conventional charging method only utilizing the unit gain buffer 10: P=I*V=(V_{T}*C*F)*V_{P}, i.e. the capacitor 12 is first charged to the voltage V_{A} which is less than the driving voltage V_{P}, and thus power consumption can be reduced. On the other hand, if the voltage V_{A} is greater than the target voltage V_{T} and less than the driving voltage V_{P}, the capacitor 12 can be charged to the target voltage V_{A} first, wherein the target voltage V_{A} is greater than the target voltage V_{T}, and then the unit gain buffer 200 adjusts the voltage across the capacitor 12 to the target voltage V_{T}. In this case, although power consumption is less reduced than the previous method (because the voltage V_{A} is greater than the target voltage V_{T}), charging speed can be improved for the capacitor 12 to rapidly achieve the target voltage V_{T}. As a result, the charging system 20 can flexibly switch the charging source of the capacitor 12 according to different requirements, to reduce power consumption or improve charging speed.

Noticeably, if the voltage V_{B} is greater than the voltage V_{A}, the switch control waveform generator 202 can also control the independent voltage source VS_{A} to charge the capacitor 12 to the corresponding voltage V_{A}, then control the independent voltage source VS_{B} to charge the capacitor 12 to the corresponding voltage V_{B}, and then control the unit gain buffer 200 to charge the capacitor 12 to the target voltage V_{T} in the cycle. In such a condition, since the capacitor 12 is charged with the smaller voltage V_{A} first and then with the greater voltage V_{B}, more power is saved than the case that the capacitor 12 is only charged with the greater voltage V_{B}. As a result, the charging system 20 can charge the capacitor 12 with different voltages sequentially from small to large, to further reduce power consumption.

For example, please refer to FIG. 2A together with FIG. 2B to FIG. 2G. FIG. 2B is a schematic diagram of a voltage to digital code conversion information VDI; FIG. 2C is a schematic diagram of dividing the driving voltage V_{P} into ranges R_{A}, R_{B}, and R_{C}; FIG. 2D is a schematic diagram of waveform signals W_{T}, W_{A}, and W_{B}; FIG. 2E to FIG. 2G are schematic diagrams of switches S_{T}, S_{A}, and S_{B} to be turned on in the cycle under different conditions. As shown in FIG. 2A, a display data generator 22 outputs a digital code DV_{T} of a target voltage V_{T}, e.g. 8 bits, a gamma generator 24 divides a gamma curve to correspond different digital codes to different voltages to generate the voltage to digital code conversion information VDI, e.g. the 8-bit digital codes are corresponding to 256 voltages as shown in FIG. 2B, a digital to analog converter 26 generates the target voltage V_{T} in an analog form according to the digital code DV_{T} of the target voltage V_{T} and the voltage to digital code conversion information VDI.

In this embodiment, the charging system 20 further includes a voltage range determination circuit 204. The voltage range determination circuit 204 divides the driving voltage V_{P} to the ranges R_{A}, R_{B}, and R_{C} according to the voltages V_{A} and V_{B}, and determines the target voltage V_{T} located in one of the ranges R_{A}, R_{B}, and R_{C}, to generate the control signal Con, wherein the range R_{A} has a lower limit of voltage 0 and an upper limit of the voltage V_{A}, the range R_{B} has a lower limit of the voltage V_{A} and an upper limit of the voltage V_{B}, and the range R_{C} has a lower limit of the voltage V_{B} and an upper limit of the voltage V_{P}. In the case that the voltage range determination circuit 204 is a digital circuit, the voltage range determination circuit 204 receives the digital codes DV_{T}, DV_{A}, and DV_{B} of the target voltage V_{T}, and the voltages V_{A} and V_{B}, to determine the target voltage V_{T} located in one of the ranges R_{A}, R_{B}, and R_{C}, and generate the control signal Con, which includes the control codes D₀ and D₁. For example, when the target voltage V_{T} is located in the range R_{A}, the control signal Con is D₁D₀=00, when the target voltage V_{T} is located in the range R_{B}, the control signal Con is D₁D₀=01, and when the target voltage V_{T} is located in the range R_{C}, the control signal Con is D₁D₀=10. In such a situation, the switch control waveform generator 202 performs logic operation to the waveform signals W_{T}, W_{A}, and W_{B} shown in FIG. 2D, to switch a charging source of the capacitor 12 when the control signal Con indicates different control codes D₁ and D₀, i.e. different ranges, so as to reduce power consumption or improve charging speed.

In detail, when the target voltage V_{T} is located in one of the ranges R_{A}, R_{B}, and R_{C}, the control signal Con indicates the switch control waveform generator 202 to control one of the independent voltage sources VS_{A} and VS_{B} to charge the capacitor 12 to a corresponding voltage first, i.e. the voltage V_{A} or V_{B}, and then control the unit gain buffer 200 to charge the capacitor 12 to the target voltage V_{T} in the cycle. In such a condition, as shown in upper half part of FIG. 2F, middle part of FIG. 2G, and lower half part of FIG. 2G, the corresponding voltage to which the capacitor 12 is charged first can be less than or equal to a lower limit of the range, such that the capacitor 12 can be charged with a voltage less than the driving voltage V_{P} first, and thus power consumption can be effectively reduced. Besides, as shown in lower half part of FIG. 2E and lower half part of FIG. 2F, i.e. the part of the switch S_{B} and the corresponding voltage V_{B}, the corresponding voltage to which the capacitor 12 is charged first can be an upper limit of the range, such that the capacitor 12 can be charged to a voltage greater than the target voltage V_{T} first, and then the unit gain buffer 200 adjusts the voltage across the capacitor 12 to the target voltage V_{T}. In this case, although power consumption is reduced less than the previous method (because the voltage V_{A} is greater than the target voltage V_{T}), charging speed can be improved for the capacitor 12 to rapidly achieve the target voltage V_{T}.

Moreover, as shown in lower half part of FIG. 2F and upper half part of FIG. 2G, in the cycle, the control signal Con can also indicate the switch control waveform generator 202 to control another one of the independent voltage sources VS_{A} and VS_{B}, e.g. the independent voltage source VS_{A}, to charge the capacitor 12 to another corresponding voltage, e.g. the voltage V_{A}, then control the independent voltage source, e.g. the independent voltage source VS_{B}, to charge the capacitor 12 to the corresponding voltage, e.g. the voltage V_{B}, and then control the unit gain buffer 200 to charge the capacitor 12 to the target voltage V_{T}, wherein the corresponding voltage is greater than the another corresponding voltage. In such a condition, since the capacitor 12 is charged with the smaller voltage first and then with the greater voltage, more power is saved than the case that the capacitor 12 is charged only with the greater voltage. In other words, the charging system 20 can charge the capacitor 12 with different voltages sequentially from small to large, to further reduce power consumption. Finally, as shown in upper half part of FIG. 2E, in the case that the target voltage V_{T} is located in the range R_{A}, if the capacitor 12 is not desired to be charged greater than the target voltage V_{T}, the capacitor 12 can only be charged with the unit gain buffer 12, too. In this case, power consumption is not reduced.

Noticeably, the spirit of the present invention is to flexibly switch the charging source of the capacitor 12 according to different requirements, to reduce power consumption or improve charging speed. Those skilled in the art can make modifications and alterations accordingly. For example, in the above embodiment, the voltages V_{A} and V_{B} provided by the independent voltage sources VS_{A} and VS_{B} are both less than the driving voltage V_{P}; in other embodiments, the voltage provided by the independent voltage source can also be greater than the driving voltage V_{P}, to charge the capacitor 12 to the voltage greater than the target voltage V_{T} and the driving voltage V_{P} first, and then the unit gain buffer 200 adjusts the voltage across the capacitor 12 to the target voltage V_{T}. In this case, although power consumption is larger than charging the capacitor 12 only with the unit gain buffer 10 in the prior art (because the voltage is greater than the driving voltage V_{P}), charging speed can further be improved for the capacitor 12 to rapidly achieve the target voltage V_{T}. Besides, the above switches S_{T}, S_{A}, and S_{B} are illustrated as MOSFET, which are not limited to NMOS, PMOS, or CMOS, and can be other types of switch; the independent voltage sources VS_{A}, VS_{B} can be linear regulator or switch regulator, which is not limited herein.

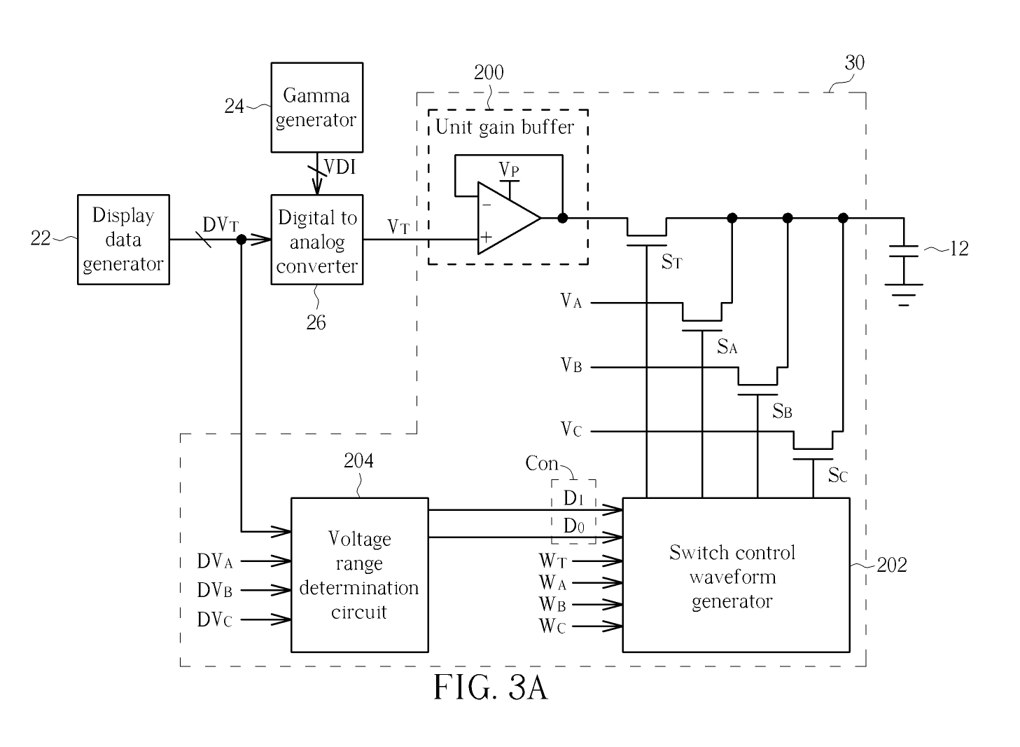

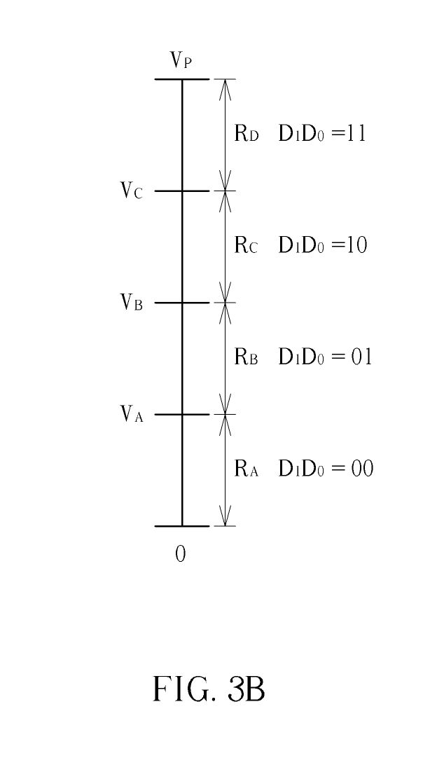

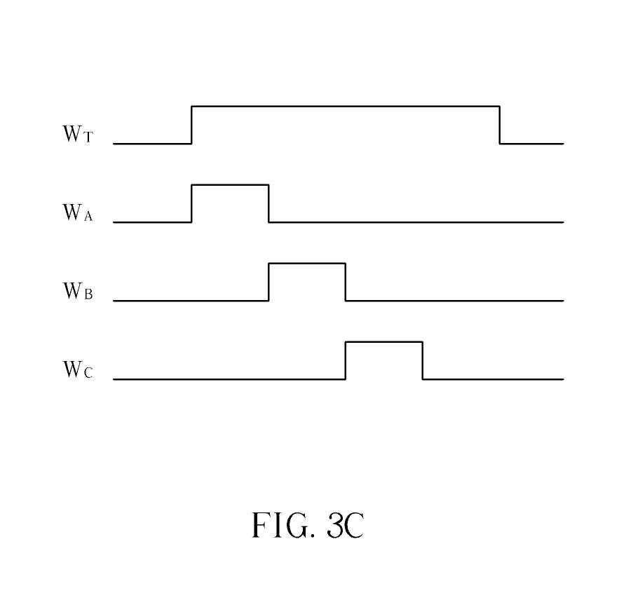

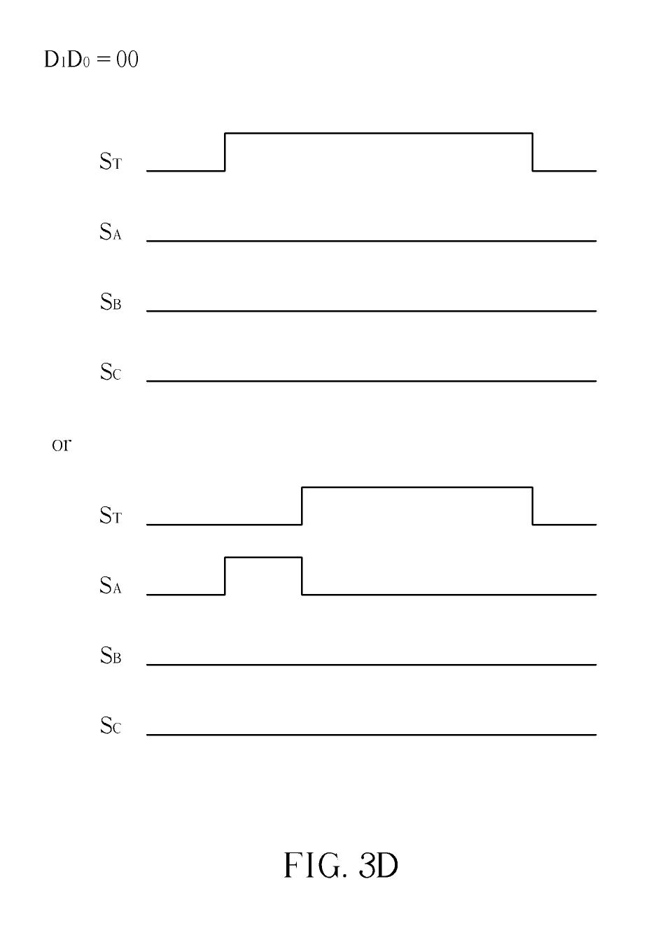

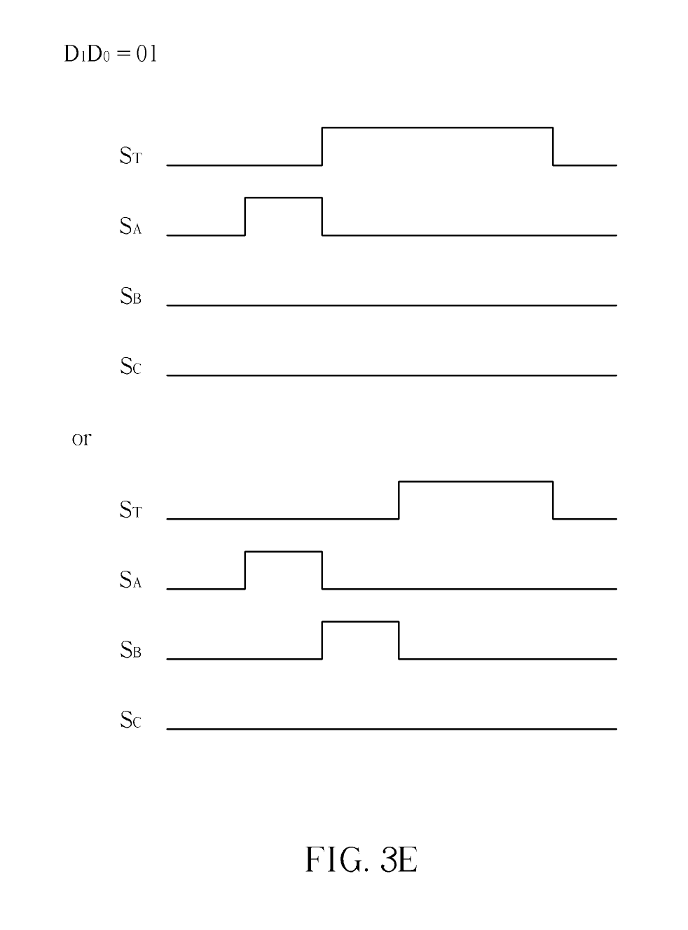

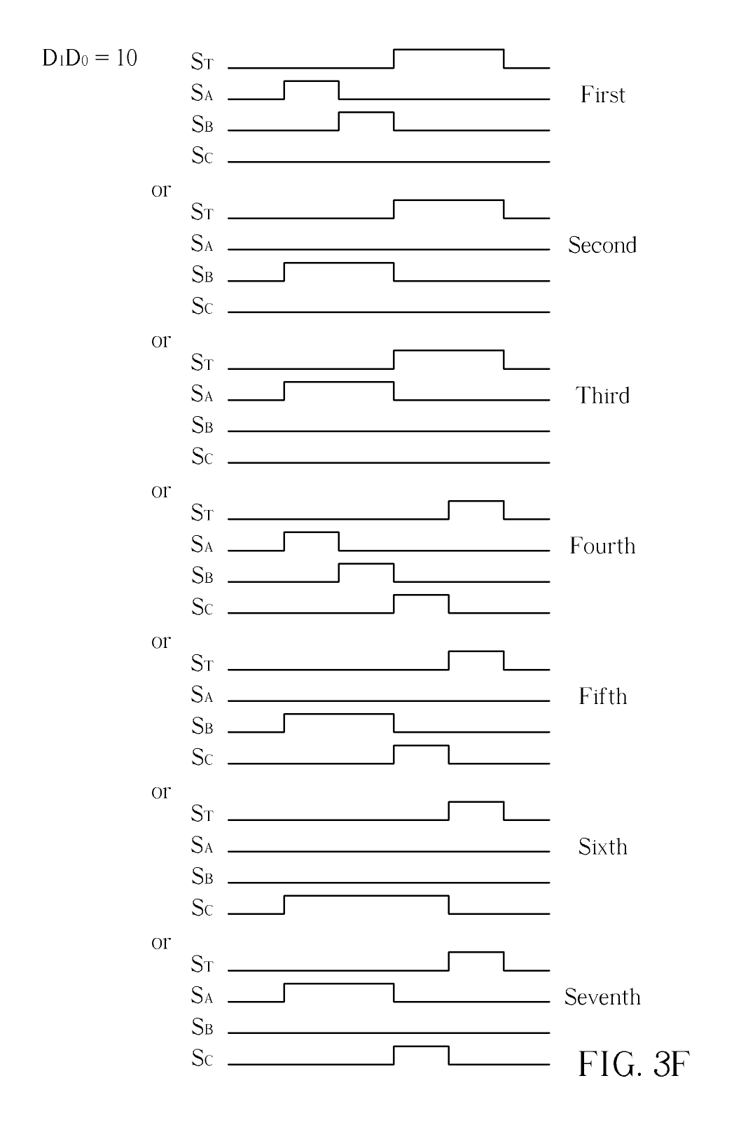

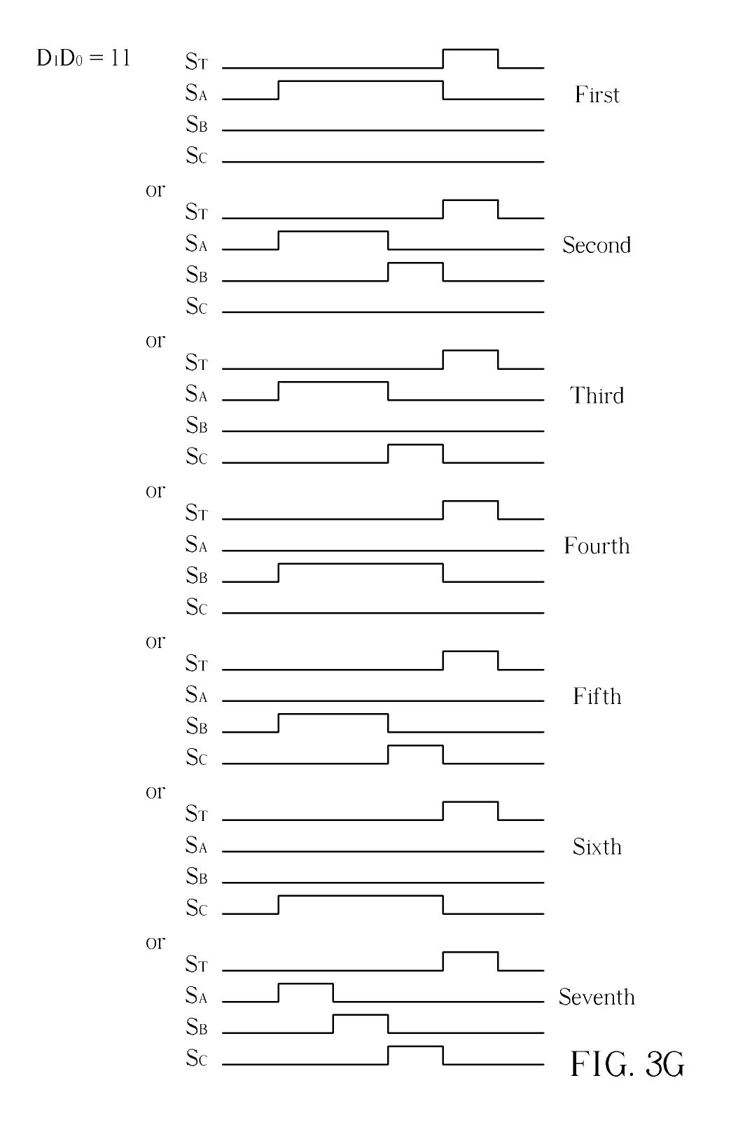

Besides, number of independent voltage sources and corresponding components is not limited to which shown in the above embodiment, and can be other numbers, i.e. the present invention is not limited to determine the target voltage V_{T} located in one of the three ranges according to two independent voltage sources, wherein number of ranges can be any one. For example, please refer to FIG. 3A to FIG. 3G. FIG. 3A is a schematic diagram of an another charging system 30 according to an embodiment of the present invention; FIG. 3B is a schematic diagram of dividing the driving voltage V_{P} to ranges R_{A}, R_{B}, R_{C}, and R_{D}; FIG. 3C is a schematic diagram of waveform signals W_{T}, W_{A}, W_{B}, and W_{C}; FIG. 3D to FIG. 3G are schematic diagrams of switches S_{T}, S_{A}, S_{B}, and S_{C} to be turned on in the cycle under different conditions. As shown in FIG. 3A, the charging system 30 is similar to the charging system 20, and thus components and signals with similar functions are denoted by the same symbols. The main difference between the charging system 30 and the charging system 20 is that the charging system 30 further includes an independent voltage source VS_{C} for providing a voltage V_{C} less than the driving voltage V_{P}, and a switch S_{C} coupled between the independent voltage source VS_{C} and the capacitor 12, such that the voltage range determination circuit 204 further determines if the target voltage V_{T} is located in a range R_{D} according to a digital code DV_{S} of the voltage V_{C} to generate the corresponding control signal Con, i.e. control codes D₁D₀=11, such that the switch control waveform generator 202 performs logic operation to the waveform signals W_{T}, W_{A}, W_{B} and W_{C} shown in FIG. 3C, to switch a charging source of the capacitor 12 when the control signal Con indicates different control codes D₁ and D₀, i.e. different ranges, so as to reduce power consumption or improve charging speed.

In such a situation, when the target voltage V_{T} is located in one of the ranges R_{A}, R_{B}, R_{C}, and R_{D}, in the cycle, the control signal Con also indicates the switch control waveform generator 202 to control one of the independent voltage sources VS_{A}, VS_{B}, and VS_{C} to charge the capacitor 12 to a corresponding voltage, i.e. the voltage V_{A}, V_{B}, or V_{C}, and then control the unit gain buffer 200 to charge the capacitor 12 to the target voltage V_{T}. In such a condition, as shown in upper half part of FIG. 3E, second part of FIG. 3F, third part of FIG. 3F, first part of FIG. 3G, fourth part of FIG. 3G, and sixth part of FIG. 3G, the corresponding voltage to which the capacitor 12 is charged first can be less than or equal to a lower limit of the range, such that the capacitor 12 can be charged with a voltage less than the driving voltage V_{P} first, and thus power consumption can be effectively reduced. Besides, as shown in lower half part of FIG. 3D, lower half part of FIG. 3E, i.e. the part of the switch S_{B} and the corresponding voltage V_{B}, and fourth to seventh parts of FIG. 3F, i.e. the part of the switch S_{C} and the corresponding voltage V_{C}, the corresponding voltage to which the capacitor 12 is charged first can be an upper limit of the range, such that the capacitor 12 can be charged to a voltage greater than the target voltage V_{T} first, and then the unit gain buffer 200 adjusts the voltage across the capacitor 12 to the target voltage V_{T}. In this case, although power consumption is reduced less than the previous method (because the corresponding voltage is greater than the target voltage V_{T}), charging speed can be improved for the capacitor 12 to rapidly achieve the target voltage V_{T}.

Moreover, as shown in lower half part of FIG. 3E, first, fourth, fifth, and seventh parts of FIG. 3F, and second, third, fifth, and seventh parts of FIG. 3G, in the cycle, the control signal Con can also indicate the switch control waveform generator 202 to control another one of the independent voltage sources VS_{A}, VS_{B}, and VS_{C}, e.g. the independent voltage source VS_{A} or VS_{B}, to charge the capacitor 12 to another corresponding voltage, e.g. the voltage V_{A} or V_{B}, then control the independent voltage source, e.g. the independent voltage source VS_{B} or VS_{C}, to charge the capacitor 12 to the corresponding voltage, e.g. the voltage V_{B} or V_{C}, and then control the unit gain buffer 200 to charge the capacitor 12 to the target voltage V_{T}, wherein the corresponding voltage is greater than the another corresponding voltage. In such a condition, since the capacitor 12 is charged with the smaller voltage first and then with the greater voltage, more power is saved than the case that the capacitor 12 is only charged with the greater voltage. In other words, the charging system 20 can charge the capacitor 12 with different voltages sequentially from small to large, to further reduce power consumption. Finally, as shown in upper half part of FIG. 3D, in the case that the target voltage V_{T} is located in the range R_{A}, if the capacitor 12 is not desired to be charged greater than the target voltage V_{T}, the capacitor 12 can only be charged with the unit gain buffer 12, too. In this case, power consumption is not reduced. Other detailed operation methods about the charging system 30 can be referred to the above description about the charging system 20.

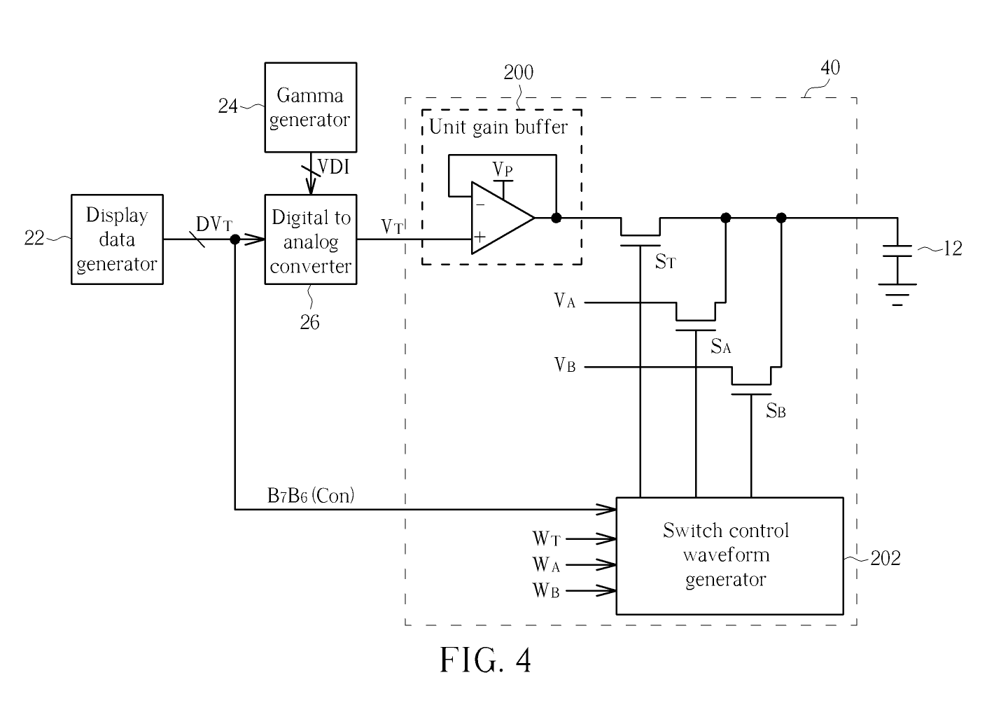

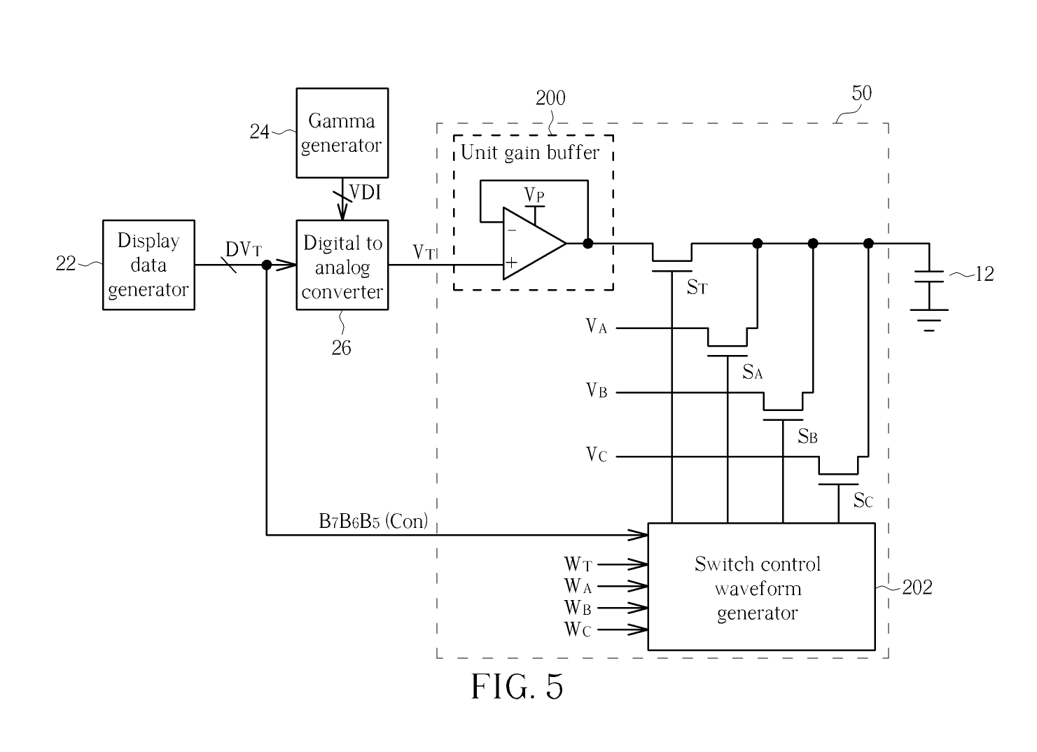

In addition, in the above embodiments shown in the FIG. 2A and FIG. 3A, the voltage range determination circuit 204 is a digital circuit and determines in which range the target voltage V_{T} located to generate the control codes D₀ and D₁ as the control signal Con, but the method for generating the control signal Con is not limited to this. For example, please refer to FIG. 4 and FIG. 5, which are schematic diagrams of the charging systems 40 and 50, respectively, according to an embodiment of the present invention. The charging systems 40 and 50 are similar to the charging systems 20 and 30, respectively, and thus components and signals with similar functions are denoted by the same symbols. The main difference between the charging systems 40 and 50 and the charging systems 20 and 30 is that the charging systems 40 and 50 do not include the voltage range determination circuit 204, and directly utilize at least one of the digital codes among the digital code DV_{T} of the target voltage V_{T} as the control signal Con. For example, if the digital code DV_{T} of the target voltage V_{T} has 8 bits, e.g. B₇ to B₀, since several most significant bits of the digital code DV_{T} can approximately divide the driving voltage V_{P} to at least one range, the charging system 40 can divide the driving voltage V_{P} to three ranges according to the digital codes B₇B₆, and then utilize the digital codes B₇B₆ as the control signal Con to control the switch control waveform generator 202, wherein the function of the digital codes B₇B₆ is similar to the control codes D₀, and D₁, and the charging system 50 can divide the driving voltage V_{P} to four ranges according to the digital codes B₇B₆B₅, and then utilize the digital codes B₇B₆B₅ as the control signal Con to control the switch control waveform generator 202, wherein the function of the digital codes B₇B₆B₅ is similar to the control codes D₀, and D₁. Other detailed operation methods about the charging systems 40 and 50 can be referred to the above description about the charging systems 20 and 30.

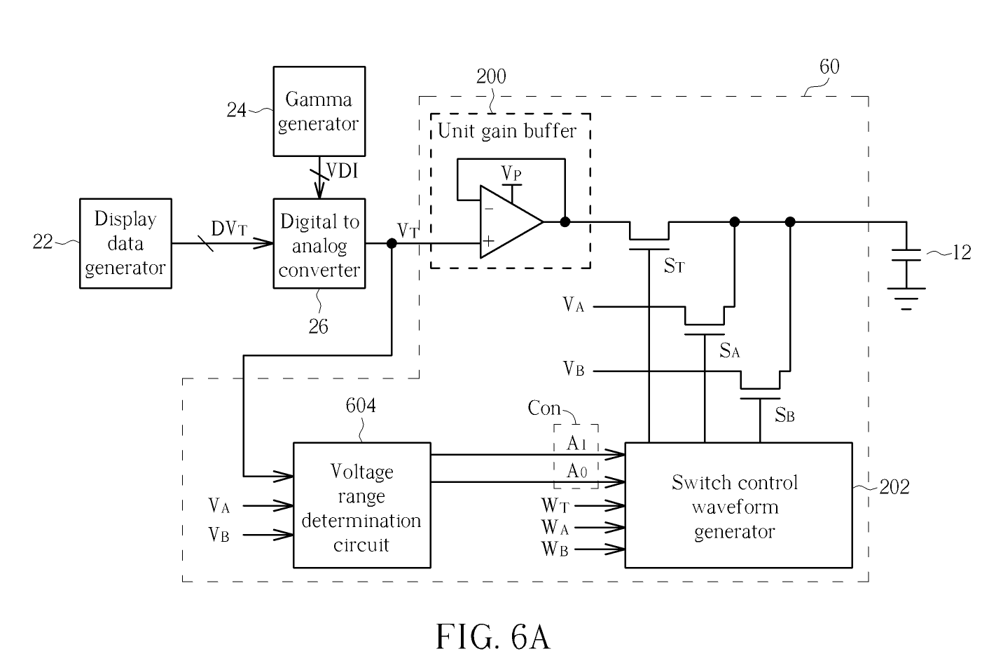

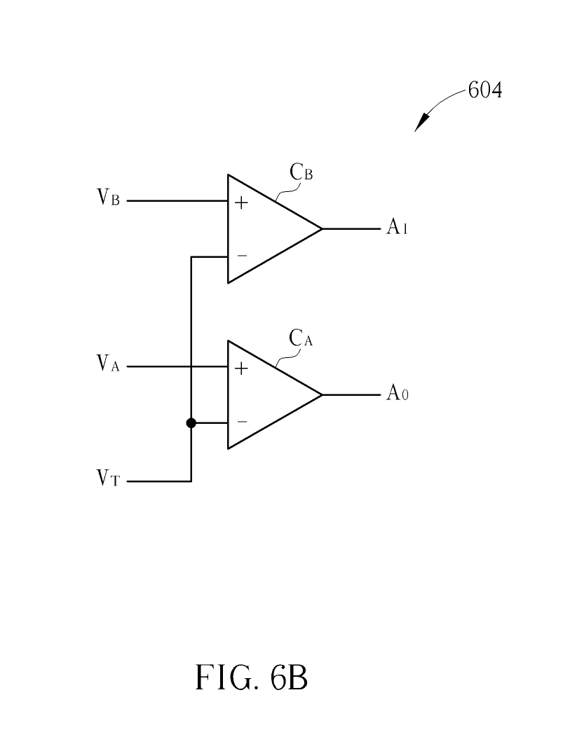

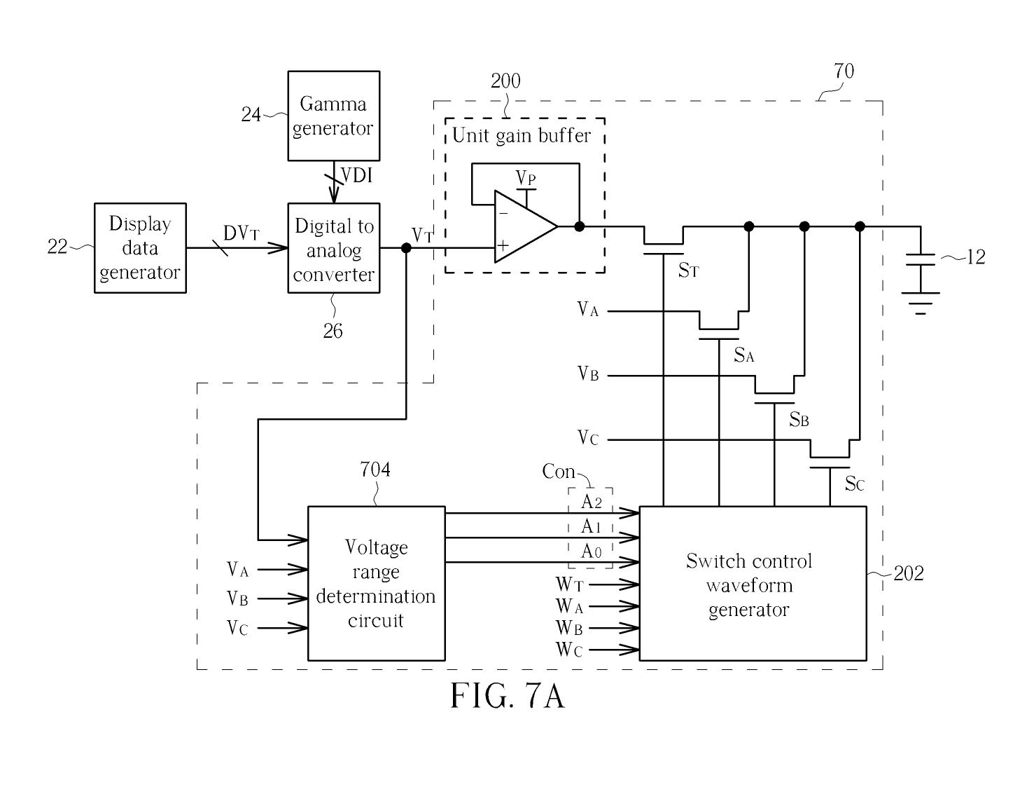

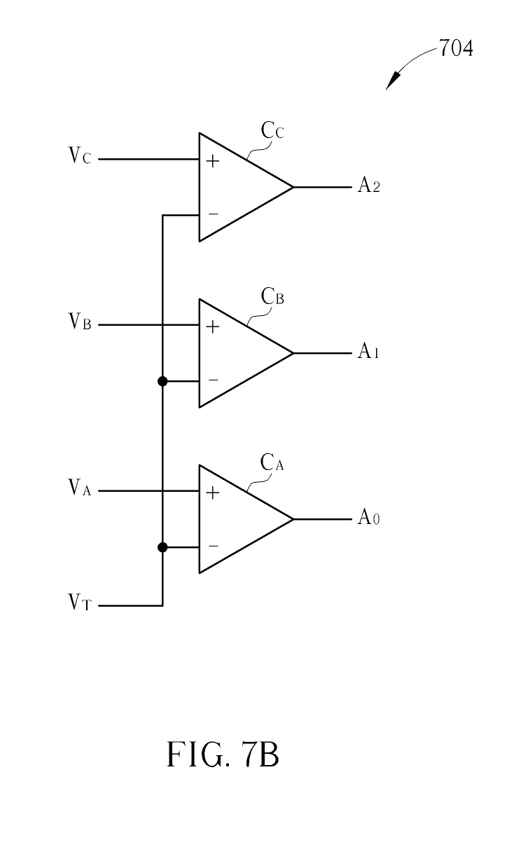

Moreover, in the above embodiments shown in the FIG. 2A and FIG. 3A, the voltage range determination circuit 204 is a digital circuit and determines in which range the target voltage V_{T} located to generate the control codes D₀ and D₁ as the control signal Con, but the voltage range determination circuit can also be realized as an analog circuit. For example, please refer to FIG. 6A and FIG. 7A, which are schematic diagrams of the charging systems 60 and 70, respectively, according to an embodiment of the present invention. The charging systems 60 and 70 are similar to the charging systems 20 and 30, respectively, and thus components and signals with similar functions are denoted by the same symbols. The main difference between the charging system 60 and the charging system 20 is that the voltage range determination circuit 604 included in the charging system 60 is an analog circuit. The voltage range determination circuit 604 receives the target voltage V_{T} and the voltages V_{A} and V_{B}, to determine the target voltage V_{T} located in one of the ranges R_{A}, R_{B}, and R_{C}, and generate the control signal Con, which includes comparison results A₁ and A₀. The main difference between the charging system 70 and the charging system 30 is that the voltage range determination circuit 704 included in the charging system 70 is an analog circuit. The voltage range determination circuit 704 receives the target voltage V_{T} and the voltages V_{A}, V_{B}, and V_{C}, to determine the target voltage V_{T} located in one of the ranges R_{A}, R_{B}, R_{C}, and R_{D}, and generate the control signal Con, which includes comparison results A₂, A₁, and A₀.

In detail, please refer to FIG. 6B and FIG. 7B, which are schematic diagrams of the voltage range determination circuits 604 and 704, respectively. As shown in FIG. 6A, the voltage range determination circuit 604 includes comparators C_{A} and C_{B} utilized for comparing the target voltage V_{T} with the voltages V_{A} and V_{B}, respectively, to determine the target voltage V_{T} located in one of the ranges R_{A}, R_{B}, and R_{C}, and generate the comparison results A₁ and A₀ as the control signal Con, wherein the function of the comparison results A₁ and A₀ is similar to the control codes D₀ and D₁. On the other hand, the voltage range determination circuit 704 includes comparators C_{A}, C_{B}, and C_{C} utilized for comparing the target voltage V_{T} with the voltages V_{A}, V_{B}, and V_{C}, respectively, to determine the target voltage V_{T} located in one of the ranges R_{A}, R_{B}, R_{C}, and R_{D}, and generate the comparison results A₂, A₁, and A₀ as the control signal Con, wherein the function of the comparison results A₂, A₁, and A₀ is similar to the control codes D₀ and D₁. Other detailed operation methods about the charging systems 60 and 70 can be referred to the above description about the charging systems 20 and 30.

In the prior art, the method of charging the capacitor 12 with only the unit gain buffer 10 lacks flexibility in power consumption and charging speed, which may cause power consumption too high or charging speed too low. In comparison, the present invention can flexibly switch the charging source of the capacitor 12 according to different requirements, to reduce power consumption or improve charging speed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charging system, for charging a capacitor, comprising:
a unit gain buffer, driven by a driving voltage, comprising a positive input terminal for receiving a target voltage, and a negative input terminal coupled to an output terminal of the unit gain buffer;
at least one independent voltage source, for providing at least one voltage;
a first switch, coupled between the output terminal of the unit gain buffer and the capacitor;
at least one second switch, coupled between the at least one independent voltage source and the capacitor; and
a switch control waveform generator, coupled to the first switch and the at least one second switch, for controlling at least one of the first switch and the at least one second switch to be sequentially turned on in one cycle according to a control signal, to sequentially charge the capacitor with at least one of the unit gain buffer and the at least one independent voltage source.

2. The charging system of claim 1, wherein the switch control waveform generator controls a first independent voltage source among the at least one independent voltage source to charge the capacitor to a corresponding first voltage, and controls the unit gain buffer to charge the capacitor to the target voltage in the cycle.

3. The charging system of claim 2, wherein the first voltage is less than the target voltage and the driving voltage.

4. The charging system of claim 2, wherein the first voltage is greater than the target voltage and less than the driving voltage.

5. The charging system of claim 2, wherein the switch control waveform generator controls the first independent voltage source among the at least one independent voltage source to charge the capacitor to the corresponding first voltage, then controls a second independent voltage source to charge the capacitor to a corresponding second voltage, and then controls the unit gain buffer to charge the capacitor to the target voltage in the cycle, wherein the second voltage is greater than the first voltage.

6. The charging system of claim 1, further comprising a voltage range determination circuit, for dividing the driving voltage to at least one range according to the at least one voltage, and determining the target voltage located in one of the at least one range, to generate the control signal.

7. The charging system of claim 6, wherein the voltage range determination circuit is a digital circuit, for receiving digital codes of the target voltage and the at least one voltage, to determine the target voltage located in the one of the at least one range, and generating the control signal.

8. The charging system of claim 6, wherein when the target voltage is located in a range among the at least one range, the control signal indicates the switch control waveform generator to control a third independent voltage source among the at least one independent voltage source to charge the capacitor to a corresponding third voltage, and then controls the unit gain buffer to charge the capacitor to the target voltage in the cycle.

9. The charging system of claim 8, wherein the third voltage is less than or equal to a lower limit of the range.

10. The charging system of claim 8, wherein the third voltage is an upper limit of the range.

11. The charging system of claim 8, wherein when the target voltage is located in the range among the at least one range, the control signal indicates the switch control waveform generator to control a fourth independent voltage source among the at least one independent voltage source to charge the capacitor to a corresponding fourth voltage, then control the third independent voltage source to charge the capacitor to the third voltage, and then control the unit gain buffer to charge the capacitor to the target voltage in the cycle, where the third voltage is greater than the fourth voltage.

12. The charging system of claim 2, wherein the first voltage is greater than the driving voltage.

13. The charging system of claim 1, wherein the control signal is at least one digital code among digital codes of the target voltage.

14. The charging system of claim 6, wherein the voltage range determination circuit is an analog circuit, for receiving the target voltage and the at least one voltage, to determine the target voltage located in the one of the at least one range, and generating the control signal.

15. The charging system of claim 14, wherein the voltage range determination circuit comprises at least one comparator, for comparing the target voltage and the at least one voltage, to determine the target voltage located in one of the at least one range, and generating at least one comparison result as the control signal.
